(19) United States
(12) Patent Application Publication
(10) Pub. No.: US 2025/0121565 A1
(43) Pub. Date: Apr. 17, 2025

(54) BOTTOM-UP PHOTO-CURING THREE-DIMENSIONAL PRINTING PROCESS BASED ON THE PRINCIPLE OF POLYMERISATION OF A PHOTOPOLYMER ON A VARIABLE PROFILE EXTRACTION SUPPORT

(71) Applicant: AXTRA3D INCORPORATION, Dover, DE (US)

(72) Inventor: Gianni ZITELLI, Padova (IT)

(73) Assignee: AXTRA3D INCORPORATION, Dover, DE (US)

(21) Appl. No.: 18/693,820

(22) PCT Filed: Oct. 13, 2022
(86) PCT No.: PCT/EP2022/078551

§ 371 Date: Mar. 20, 2024

(30) Foreign Application Priority Data
Oct. 14, 2021 (IT) 102021000026378

(51) Int. Cl. B29C 64/40; B29C 64/264; B29K 21/00; B29L 31/00; B33Y 10/00; B33Y 30/00; B33Y 40/20; B33Y 80/00

(52) U.S. Cl. CPC B29C 64/40; B29C 64/264; B33Y 10/00; B33Y 30/00; B33Y 40/20; B33Y 80/00; B29K 2021/00; B29L 2031/753

(57) ABSTRACT

The present invention concerns a bottom-up type photo-curing three-dimensional printing process, comprising the following steps:
forming a support (11, 33, 41) on an extraction plate (12, 34), by the photo-curing of successive layers of a photopolymer material, the imprint of at least a portion of the object (10, 30, 40) to be formed being formed on said support (11, 33, 41);
completing the curing of the photopolymer material of said support (11, 33, 41);
forming the object (10, 30, 40) to be printed on said support (11, 33, 41), by the photo-curing of a photopolymer material; and
detaching the obtained object (10, 30, 40) from said support (11, 33, 41).

The present invention concerns a bottom-up type photo-curing three-dimensional printing process, based on the principle of polymerisation of a photopolymer on a variable profile extraction support.

More specifically, the invention relates to an innovative methodology for producing three-dimensional objects, by means of a photo-curing process of photosensitive materials, which allows to create three-dimensional objects according to a sequential forming process, considerably increasing the speed, the precision and the mechanical qualities of the final product, compared to what can be obtained through methodologies of a known type.

The invention refers to the field of three-dimensional printing, commonly called 3D-printing, and in particular to the 3D-printing technology by photo-curing, i.e. curing of a particular type of polymer as a result of the exposure to a light radiation.

It is known that in the field of photo-curing 3D printing technology two basic technologies can be included, the stereolithographic printing, wherein a laser emitting in the UV band is used to solidify a photo-curing polymer in its liquid state which is in a proper tank by means of its emitted beam; and the DLP (acronym of the English expression Digital Light Processing) printing, according to which a photo-curing polymer (or photo-curing liquid resin), always in its liquid state in a tank, is exposed to the light radiation emitted by a device similar to a projector.

According to both these technologies, the printing procedure proceeds by creating one layer after another, i.e. by solidifying a first layer adhering to a support plate (or extraction plate) and subsequently a second layer adhering to said first layer and so on until the object is completely formed. According to this technology, therefore, data representing the three-dimensional object to be created are organised as a series of two-dimensional layers representing the object cross-sections.

In particular, the bottom-Up process, applied to both laser and DLP type machines, provides that the object extraction plate, which is typically also called a build platform, moves from the bottom upwards, with a layer-by-layer tilting movement.

Basically, the process forming the three-dimensional object consists of the following:
a software divides the 3D model, provided as input for printing, into an ordered succession of layers, having a thickness determined according to the adopted technology, the polymer opacity, the amount of photoinitiator, the degree of precision to be obtained and the characteristics of the supplied machine, usually between 25 and 200 μm, but, in any case, a succession of a discrete and finite number of layers;
a support plate, also called extraction plate or build platform, consisting of a material able to facilitate the adhesion thereon of the first layer of polymer, moves to a predetermined distance from the first layer and waits for the light beam (laser and/or DLP) solidifying the first layer; then it rises at a distance sufficient to cause the layer just formed to detach itself from the bottom of the tank (usually about 1 mm) and then it lowers again at the same distance, minus the distance set for forming the second layer, and so on until the whole object is formed.

The resulting back-and-forth movement of the support plate, also called tilting movement, has two main purposes: it allows the just formed layer to detach itself from the bottom of the tank, and at the same time allows a new amount of unpolymerised liquid resin to interpose between the just formed layer and the bottom of the container, to allow the renewal of material still in its liquid state under the already solidified layer, for curing and forming the next layer.

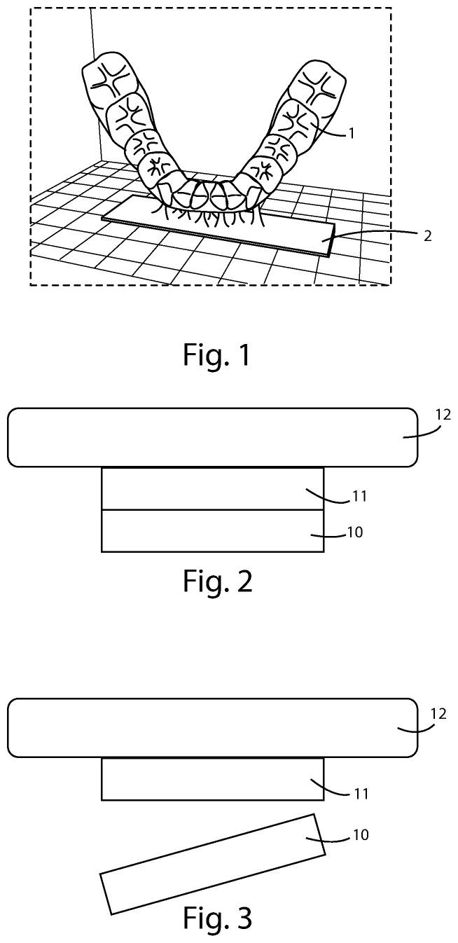

In some cases, according to the known technique, in bottom-up type printing processes, for properly forming the object it is necessary that supports are also formed at the same time, which support the growth of the object, starting from the support plate or extraction plate, respectively. An example is shown in FIG. 1, wherein the printed object, indicated by the numerical reference 1 is supported by a support 2. The supports thus formed are therefore an integral part of the printed object and must be removed after the creation of the object. This removal is done manually and involves some important limitations, such as in particular an increase in the unit cost of production, a reduction of the production speed, a lower quality of the printed objects at the junction points with the supports, a greater consumption of the photopolymer material for making the supports, intended to be discarded.

It follows that, because of the costs for the labor required for removing the supports, of the higher costs for purchasing the photopolymer material intended to be discarded, and of the reduced volumes due to the longer production time, the bottom-up type photocuring three-dimensional printing technology is not conveniently applicable in some fields, such as, for example, in the market of orthodontic devices, in the production of splints/bites and dental aligners.

The solution according to the present invention fits in this context, aiming to provide a bottom-up type photo-curing three-dimensional printing process without forming supports integrated with the printed object, to be manually removed after having created the object.

These and other results are obtained according to the present invention by proposing a bottom-up type photo-curing three-dimensional printing process based on the principle of polymerisation, e.g. extra-polymerisation, of a photopolymer located on a variable profile extraction support not chemically and mechanically coupled to the printed object.

The aim of the present invention is therefore to provide a bottom-up type photo-curing three-dimensional printing process which allows to overcome the limits of the three-dimensional printing processes according to the known technology and to obtain the technical results previously described.

A further aim of the invention is that said bottom-up type photo-curing three-dimensional printing process can be carried out at substantially low cost.

Last but not the least aim of the invention is to propose a bottom-up type photo-curing three-dimensional printing process that is simple, safe and reliable.

Therefore, a specific aim of the present invention is a bottom-up type photo-curing three-dimensional printing process, comprising the following steps:
forming the object to be printed on a support, on which there is the imprint of at least a portion of the object to be printed, by the photo-curing of a photopolymer material; and
detaching the obtained object from said support.

As will be clear from further below, the support is typically, a component which has been printed on an extraction plate or build platform, respectively. The support can thus, also be deemed or denoted a support component, particularly a printed support component.

Alternatively, according to the invention, said bottom-up type photo-curing three-dimensional printing process comprises the following preliminary step:
applying a previously formed support on an extraction plate; or the following preliminary steps:
forming a support on an extraction plate or build platform, by the photo-curing of successive layers of a photopolymer material; and
completing the curing of the photopolymer material of said support.

In particular, according to the invention, said step of completing the curing of the photopolymer material of said support includes closing the polymerisation chains.

Closing the polymerization chains typically means that the polymerization chains of the photopolymer material are closed above a polymerization threshold value. The polymerisation threshold value is particularly chosen such that a form of the cured photopolymer material does not or at least tends not to chemically couple with a second form, consisting of a second photopolymer material in a photo-curing phase. As such, a respective polymerization threshold value can refer to a closing of the polymerization chains in a percentage of at least 75%, particularly at least 80%, more particularly at least 85%, further particularly at least 90%, further particularly in a percentage of 95% or even higher than 95%.

Furthermore, according to the invention, said step of completing the curing of the photopolymer material of said support typically comprises the following sub-steps:
washing and subsequent drying of the support;
post-curing the support by exposing all its surface to an ultraviolet radiation.

The washing and subsequent drying of the support can be an optional step. The post-curing step can result in that the support is passivated, particularly chemically passivated, such that no chemical bonds can be formed with the photopolymer material used for forming/printing the actual object. Hence, a respective passivation can be based on that the post-curing increases the curing degree of the photopolymer material used for forming the support such that the support cannot chemically bond with the photopolymer material used for forming/printing the actual object.

In particular, according to the present invention, said step of forming the object to be printed on said support comprises two sub-steps:
forming a first portion of the object to be printed by polymerisation, particularly extra-polymerisation, of the photopolymer material of the object within the imprint present on said support;
forming the remaining portion of the object to be printed, by the photo-curing of successive layers of said photopolymer material of the object, starting from said first portion. As will be apparent from below, extra-polymerisation can be over-curing

Alternatively, according to the present invention, the photopolymer material of the object is identical to the photopolymer material of said support or is different from the photopolymer material of said support, and in the latter case the photopolymer material of said support is preferably an elastomeric material.

More particularly, the present invention proposes a bottom-up type photo-curing three-dimensional printing process based on the principle of polymerisation of a photopolymer material to form a support component (“support”) on an extraction plate (which can also be deemed a build platform) which photopolymer material will particularly not chemically bond or couple to an object which is to be printed on the support component. Indeed, even if there is no chemical bonding or coupling, there can be a detachable physical, particularly mechanical, coupling between the support component and the printed object. Notably, the terms “support” or “support component” do not refer to a build platform of a bottom-up type photo-curing 3d-printer used for carrying out the process but to a support object which has been printed on the build platform before the actual object to be printed is printed.

The process thus, typically comprises at least two steps which will be explained in the following:

In a first step, the or at least one support component is printed. The support component is printed with a portion comprising a negative of at least a portion of the actual object to be printed. This portion can also be deemed as the imprint mentioned above. The support component is typically printed by photocuring of a first photopolymer material.

In a second step, the actual object is printed on at least the portion of the support component which comprises the negative of at least a portion of the actual object to be printed. As such, the portion of the support component which comprises the negative of at least a portion of the actual object to be printed is used as a new surface, substrate, or underground on which the 3d-printing of the actual object is initiated. The object is typically printed by photocuring of a second photopolymer material. As will be apparent from below, the second photopolymer material can be different from the first photopolymer material. Particularly, the second photopolymer material can differ from the first photopolymer material in at least one chemical and/or physical property.

After completion of the second step, the obtained object can be detached from the support component in a third step.

Thereby, printing of the actual object typically, typically, begins with overcuring the second photopolymer material. Overcuring the second photopolymer material typically, results in that the portion of the support component which comprises the negative of at least a portion of the object to be printed is filled with (over) cured second photopolymer material. Overcuring of the second photopolymer material can comprise extra-polymerisation of the second photopolymer material as mentioned above and vice versa. After that, the remainder of the object can be printed in conventional manner on the portion of the object which has been printed in the portion of the support component which comprises the negative of the respective portion of the object to be printed, i.e. by layerwise curing of the second photopolymer material whereby each layer represents a cross-section of the object.

The support component is typically, printed from a material which is different from the material used for printing the object, and vice versa, to avoid a chemical bonding or coupling between the support component and the object. As such, the support component is typically, printed using at least one first photopolymer and the actual object is typically, printed using at least one second photopolymer which is different from the first photopolymer.

The photopolymer material used for printing the support component typically differs from the photopolymer material used for printing the actual object in at least one chemical and/or physical property. An example of a chemical property is the chemical composition, degree of curing, degree of polymerization, degree of cross-linking, etc. and related chemical behavior, particularly related chemical compatibility with other chemical compositions. An example of a physical property, is density, surface roughness, etc.

Hence, chemically and/or physically different photopolymer materials can be used for printing the support component and the actual object, respectively. The chemical and/or physical differences enable that any connection or coupling between the support component and the object can be detached without damaging or destroying the support and/or the object. Thus, the use of chemically different photopolymer materials for printing the support component and the object is preferred to avoid the possibility of forming chemical bonds between the support component and the object, particularly during printing of the object.

The photopolymer material used for the support component or the object can be or comprise an elastomeric material, such as a photopolymerizable rubber or rubber-like material. A rubber or rubber-like material can be or comprise a silicone-rubber or a silicone-based rubber. Printing the support component or the object from an elastomeric material, i.e. a material which exhibits a specific elastic deformation behavior, enables detaching the object from the support component without damaging or destroying at least the object. As such, either the photopolymer material used for printing the support component or the object can be an elastic and/or soft material (relative to the photopolymer material used for printing the object or support component, respectively) so as to enable or case detachment of the object from the support component.

The invention thus, typically comprises printing a support component on a build platform using a first photopolymer. The support component comprises an imprint of at least a portion of the actual object to be printed. The imprint provided with the support component is a negative shape of at least a portion of the object to be printed. The imprint provided with the support component can be or comprise at least one recess in a base portion of the support component which recess is a negative of the shape of at least a portion of the object to be printed.

The object to be printed is thus, partially printed inside the recess in a base portion of the support component. This also means that the radiation data particularly the image data and/or the cross-sectional data, used for printing the first layer of the actual object, which is indicative of the areas to be cured for creating the first layer of the object, typically corresponds to areas which are not to be cured in the image data and/or cross-sectional data used for printing the support component. As such, the radiation data, particularly the image data and/or the cross-sectional data, used for printing the first layer(s) of the object can be complementary to the radiation data, particularly the image data and/or the cross-sectional data, used for printing the at least the last layer(s) of the support component. Specifically, the the image data and/or the cross-sectional data, used for printing the first layer(s) of the object can be complementary to the the image data and/or the cross-sectional data used for printing the portions of the support component which delimit the recess in the base portion of the support component.

The imprint provided with the support component can also comprise at least one undercut section. A respective undercut section can enable a mechanical anchoring of the object inside the imprint of the support component. A respective anchoring can improve the (intermediate) mechanical connection between the support component and the object which can be helpful to resist forces generated by the suction-effect during the additive build-up of the object.

Another aspect of the invention relates to an object manufactured in accordance with the process specified herein. The object can be an orthodontic device, in particular a splint/bite or dental aligners. Due to the process specified herein, the structural properties, such as the mechanical properties, of respective orthodontic device can be improved relative to orthodontic devices which have been manufactured with conventional 3d-printing processes.

Another aspect of the invention relates to a bottom-up type photo-curing 3d-printer is suggested which is configured to perform the bottom-up type photo-curing three-dimensional printing process. The bottom-up type photo-curing 3d-printer comprises a controller which is configured to control operation of the bottom-up type photo-curing 3d-printer to perform the photo-curing three-dimensional printing process specified herein. All annotations concerning the bottom-up type photo-curing three-dimensional printing process also apply to the bottom-up type photo-curing 3d-printer.

The bottom-up type photo-curing 3d-printer which typically comprises at least:
a tank or vat device, the tank or vat device delimiting a receiving volume for receiving a photocurable material, particularly a photocurable resin, the bottom of the receiving volume being defined by a transparent membrane, particularly an elastic transparent membrane;
a build platform device, the build platform device comprising a build platform arranged above the membrane and moveably supported relative to the membrane in at least one degree of freedom of motion, particularly in a translational degree of freedom of motion in a vertical motion axis; and
at least one radiation device, particularly a digital light projector device and/or a laser device, disposed below the membrane, the at least one radiation device configured to emit electromagnetic radiation to selectively and successively cure the or a photocurable material provided in the receiving volume to additively manufacture a three-dimensional object in a build direction.

The bottom-up type photo-curing 3d-printer can implement principles of stereolithography to print a respective support component and object, respectively.

As indicated above, the bottom-up type photo-curing 3d-printer typically, comprises a controller configured to perform the process for printing an object specified herein. The controller is thus, particularly configured to communicate with a drive device, such as a (n electric) motor, of the build platform device and the radiation source so as to control their operation to implement the process specified herein.

The term “extra-polymerisation” and “overcuring” used herein can refer to curing of a photopolymer material which results in that the achieved thickness of the photopolymer material is higher than in normal polymerization. In other words, “extra polymerization” results in a penetration depth of the radiation which results in that a photopolymer material can be cured in the build direction with a curing depth exceeding a typical layer thickness during normal polymerization.

Hence, extra-polymerisation or overcuring, respectively can result in curing depths and thus, layer thicknesses of a photopolymer material of more than 50 μm, particularly more than 75 μm, more particularly more than 100 μm, more particularly more than 125 μm, more particularly more than 150 μm, more particularly more than 175 μm, more particularly more than 200 μm, more particularly more than 225 μm, more particularly more than 250 μm, more particularly more than 275 μm, more particularly more than 300 μm, more particularly more than 325 μm, more particularly more than 350 μm, more particularly more than 375 μm, more particularly more than 400 μm. The curing depths effected through extra-polymerisation or overcuring are typically higher than the curing depths and thus layer thickness implemented for printing the remaining layers of the object. The curing depths and thus layer thickness implemented for printing the remaining layers of the object can be denoted “standard curing depths”.

As such, extra-polymerisation can particularly result in that an imprint, e.g. a respective recess, within a base body of the support component can be filled or occupied with cured photopolymer material in a single radiation step. Hence, the radiation energy applied in the radiation step for effecting the extra-polymerisation of the photopolymer material is high enough to effect curing of the curable photopolymer material in a respective recess within the base body of the support component. Extra-polymerisation can e.g. be effected through a higher energy input, e.g. due to longer radiation times and/or higher radiation energy, for instance.

The present invention will now be described, for illustrative but not limitative purposes, according to a preferred embodiment thereof, with particular reference to the Figures of the attached drawings, where:

FIG. 1 shows a perspective view of a printed object supported by a support, obtained by means of a bottom-up type photo-curing three-dimensional printing process according to the known technique,

FIG. 2 shows a schematic representation of a first step of a printing process by subsequent photo-curing of two different photopolymer materials, with formation and complete curing of the first material and subsequent formation and curing of the second material,

FIG. 3 shows a schematic representation of a second step of the photo-curing printing process of FIG. 2,

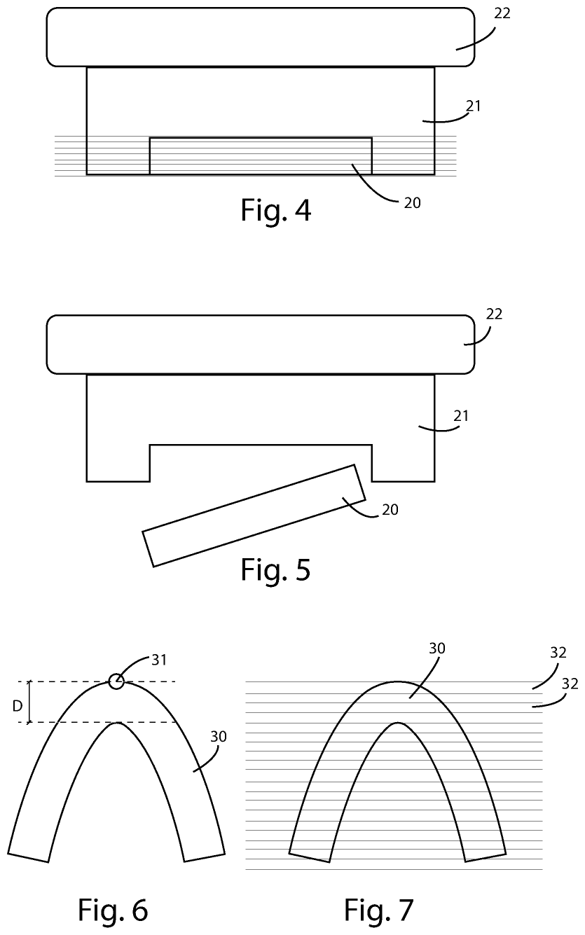

FIG. 4 shows a schematic representation of a first step of a printing process by subsequent photo-curing of two different photopolymer materials, with formation and complete curing of the first material and subsequent formation and curing of the second material by extra-polymerisation,

FIG. 5 shows a schematic representation of a second step of the photo-curing printing process of FIG. 4,

FIG. 6 shows a schematic representation of an exemplary object to be printed by the photo-curing printing process according to the present invention,

FIG. 7 shows a schematic representation of the object to be printed in FIG. 6, with indicated the thickness of the forming layers achievable by means of a photo-curing printing process according to the known technique,

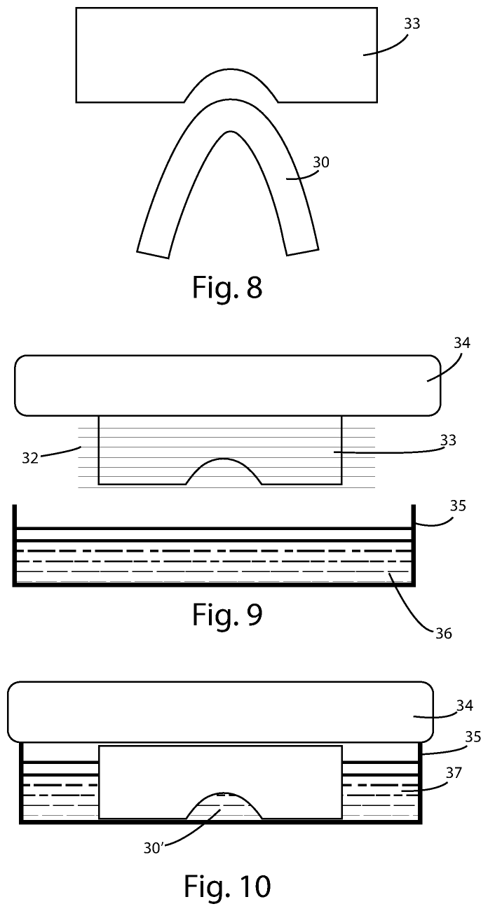

FIG. 8 shows a schematic representation of a first step of a printing process by subsequent photo-curing of two different photopolymer materials, with formation and complete curing of the first material and subsequent formation and curing of the second material by extra-polymerisation, according to the present invention,

FIG. 9 shows a schematic representation of a second step of the photo-curing printing process of FIG. 8,

FIG. 10 shows a schematic representation of a subsequent step of the photo-curing printing process of FIGS. 8 and 9,

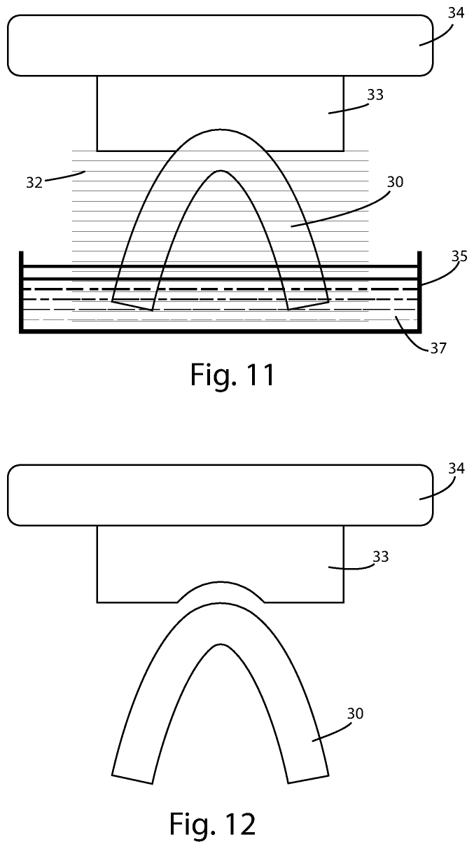

FIG. 11 shows a schematic representation of a subsequent phase of the photo-curing printing process of FIGS. 8-10,

FIG. 12 shows a schematic representation of a subsequent phase of the photo-curing printing process of FIGS. 8-11,

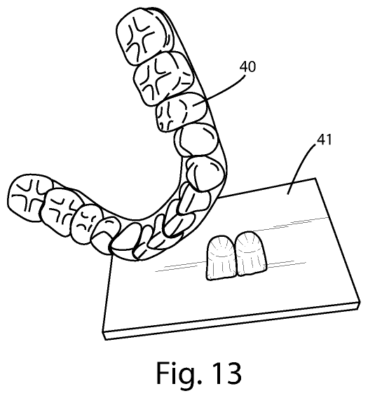

FIG. 13 shows a perspective view of a real object to be printed by means of the photo-curing printing process according to the present invention and of the corresponding support,

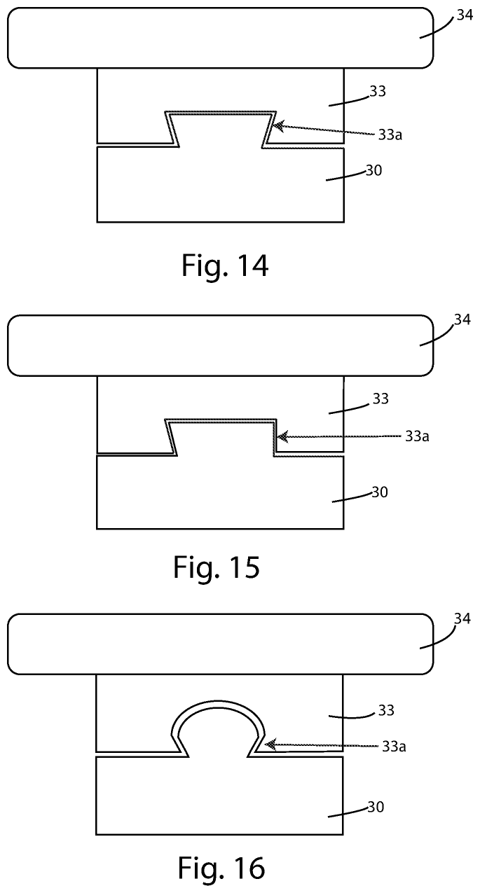

FIGS. 14-16 show exemplary schematic representations of undercut support components, and

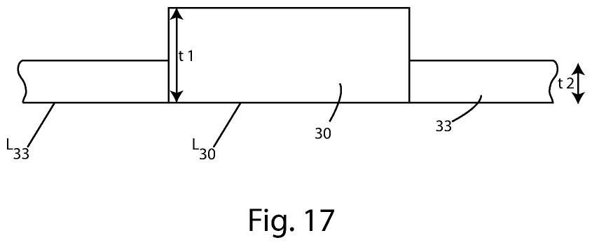

FIG. 17 shows a principle drawing of image data for printing the last layer of an exemplary support component and the first layer of an exemplary object according to an exemplary embodiment of the present invention.

With reference to the Figures, at the base of the solution according to the present invention there are two phenomena of the photopolymerisation process, which are described below.

The first of these phenomena, also verified on the basis of some experimental tests illustrated in the following description, is based on the fact that a first form, consisting of a first completely cured photopolymer material, i.e, wherein the degree of polymerisation of the chains as a result of the exposure to the light radiation is completed in a percentage higher than 95%, tends not to chemically and mechanically couple with a second form, consisting of a second photopolymer material in photo-curing phase. In particular, it has been observed that the initiators of the first photopolymer material, (essentially) completely consumed during the photopolymerisation reactions of the first material for forming the first form, have no effect on the second photopolymer material of the second form while produced in direct contact with the first form. As will be apparent from below, the first form corresponds to a support component printed on a build platform or extraction plate, whereas the second form corresponds to the actual object to be printed.

The second phenomenon underlying the solution according to the present invention is based on the known concept of extra-polymerisation or overcuring of a photopolymer material subject to a light radiation. In particular, it has been observed that, by subjecting a photopolymer material to a light radiation, e.g. by way of example an ultraviolet radiation, if the material is exposed to an energy higher than that necessary to polymerise a layer of standard thickness (e.g. of thickness between 25 and 200 μm), then the photopolymer material tends to continue the polymerisation even at greater depths, however making the shape of the object out of control (over-curing phenomenon in XYZ, particularly in the build direction (z-direction)).

As such, extra-polymerisation or over-curing typically means that a higher amount of energy is used relative to an amount of energy required for curing a given reference layer thickness, which can be a layer thickness used for curing the second and all subsequent layers of the object to be printed. This higher amount of energy will result that a cured layer is generated which has a greater layer thickness than the reference layer thickness. As indicated above, this higher amount of energy can lead to a curing of the photopolymer material in multiple directions (including the build-direction). Yet, this curing of the photopolymer material will take place inside the recess of the support component. Thus, the curing of the photopolymer material is not of disadvantage because the respective portion of the object will then be created inside the recess of the support component. This also means that extra-polymerisation and overcuring, respectively is typically effected only for curing of the first layer of the actual object.

With reference to FIG. 2, according to the present invention, by exploiting these two phenomena, an object 10 of a first material has been grown on a variable profile substrate 11 of a second material, previously formed on an extraction platform 12, and over 95% closure of the polymerisation chains of the material of the substrate 11 has been brought to curing, i.e., over 95% of the granted crosslink. The achievement of the crosslink target of the substrate material 11, hereinafter also referred to as support or support component 11, can be achieved by adopting a washing and post-curing process with the use of a UV oven or by heating the support 11. Generally, the use of undirected or directed photonic or thermal energy, e.g. by using a directed light beam to only overcure relevant surface portions of the support component 11, is conceivable.

With reference to FIG. 3, as already explained above, consequently to the achievement of a high degree of curing of the material of the support 11, the object 10 consisting of the material in curing phase does not chemically and mechanically couple with the support 11. Therefore, after having completed the step of forming the object 10, by moving the extraction platform 12 away from the bottom of the tank (not shown) which contains the liquid photopolymer material, the object 10 easily detaches itself from support 11.

This is particularly possible because the support component 11 is “passivated” due to its high degree of polymerization which hinders (chemical) bonding interaction with the curable photopolymer material used for printing the actual object 10.

Referring to FIG. 4 it is also shown how the extra-polymerisation phenomenon of a photopolymer material subject to a light radiation can be exploited for creating an object 20 which, according to the bottom-up type photo-curing three-dimensional printing processes, would have required the creation of supports integrated with the object. In fact, if, consequently to the formation and achievement of a high degree of curing of the material of a support 21, the support 21 is immersed in a tank containing a second liquid photopolymer material, and if the second photopolymer material is exposed to an energy higher than that necessary to polymerise a standard thickness layer, then the polymerisation of the second photopolymer material tends to continue in all directions where forming is not contrasted, even at greater depths, i.e. the second photopolymer material is able to form an object 20 whose shape occupies the space left free by the previously formed support 21. Also in this case, then, referring to FIG. 5, the object 20 consisting of the second photopolymer material, in curing phase, does not chemically and mechanically bond or couple with the support 21; therefore, after completing the step of forming the object 20, by moving the extraction platform 22 away from the bottom of the tank (not shown) which contains the second liquid photopolymer material, the object 20 easily detaches itself from the support 21.

With reference to the following Figures, the steps of the bottom-up type photo-curing three-dimensional printing process according to the present invention are illustrated in greater detail, which on the basis of the just illustrated principle of extra-polymerisation of a photopolymer allows to form an object on a variable profile extraction support not chemically and mechanically coupled with the object.

Referring to FIG. 6, the object to be printed is indicated with the numerical reference 30 and has a point 31, defined as the first contact point. The Figure also shows the thickness D of the object 30 at the first contact point 31. The build direction of the object 30 corresponds to the direction of the thickness D of the object 30.

FIG. 7 shows, by way of schematic example, a series of equally spaced lines 32, which represent the height of a layer that can be created, according to the known technique, by means of a bottom-up type photo-curing three-dimensional printing process without losing control over the shape of the object 30. FIG. 7 shows how the thickness D of the object 30 at the first contact point 31 is greater than the thickness of a layer.

With reference to FIG. 8, the first step of the bottom-up type photo-curing three-dimensional printing process according to the present invention envisages to design, by means of a 3D modeling software, e.g. a CAD-software, a support 33, to be made with a photopolymer material different from the material with which it will be made the object 30 to be printed, whose shape follows the imprint of at least a portion of the object 30 to be printed, starting from the first contact point 31, and arriving at a depth equal to the thickness D of the object 30 itself at the first point of contact 31. In practice, the support 33 is a cast of the imprint of the object 30 at the first contact point 31.

FIG. 9 shows the second step of the bottom-up type photo-curing three-dimensional printing process according to the present invention, according to which a support 33 is made by forming a series of layers 32 on an a build platform or extraction plate 34, proceeding according to a three-dimensional printing process according to the known technique, by the photo-curing of a liquid photopolymer material 36 contained in a tank 35 of a bottom-up type photo-curing three-dimensional printing apparatus. At the end of the step of forming the support 33, the 3D modeling software stores the position and/or orientation of the support 33 relative to the extraction plate 34 or vice versa.

According to a third step of the bottom-up type photo-curing three-dimensional printing process of the present invention, the support 33 is taken from the three-dimensional printer together with the extraction plate 34 and is washed and/or subsequently dried, to remove any residual of the liquid photopolymer material in excess, according to a washing and drying step identical to that envisaged according to the bottom-up type photo-curing three-dimensional printing processes of the known technique.

Subsequently, in a fourth step of the bottom-up type photo-curing three-dimensional printing process of the present invention, after washing and drying, the support 33, still attached to the extraction plate 34, is processed with a post-curing means, e.g. placed in an ultraviolet oven, for post-curing. During this fourth step, the photopolymer material of the support 33 reaches its threshold degree, which can be a maximum degree, of stabilization or polymerization of the photopolymer material, the photopolymerisation step is completed and the photoinitiators are inhibited for more than 95% of the photopolymer chains. In other words, the support 33 becomes stable and fully formed. Also, the support 33 becomes inactive with respect to bonding to another curable photopolymer material, particularly the one used for subsequent printing of the actual object.

Subsequently, with reference to FIG. 10, the extraction plate 34 together with the support 33 attached thereto are inserted again into the three-dimensional printer. A second liquid photopolymer material 37 is inserted in the forming tank 35, wherein the support 33 is immersed until it comes into contact with the bottom of the extraction tank 35, while the liquid photopolymer material 37 fills the space of the support 33 intended to receive the first contact point 31 of the object 30 to be printed, which was designed in the first step of the bottom-up type photo-curing three-dimensional printing process according to the present invention and formed in the second step, to form the imprint of the object 30 to be printed.

In the next step, still referring to FIG. 10, exploiting the extra-polymerisation phenomenon, the space of the support 33 intended to receive the first contact point 31 of the object 30 to be printed is subjected to the photo-curing radiation, applying an amount of energy such as to polymerise not a single layer but all the liquid photopolymer material 37 contained in such space. In other words, the amount of energy delivered must be sufficient to polymerise all the volume of the liquid photopolymer material 37 contained in such space defined by the support 33, for a depth equal to the thickness D of the object 40 to be formed at the first contact point 31.

With reference to FIG. 11, the whole object 30 is subsequently formed by curing the different forming layers (each layer being ideally delimited by two delimiting lines 32) by photopolymerisation of the liquid photopolymer material 37 of the tank 35, until completing the object 30 to be printed, as one piece with the first portion consisting of a photopolymer material which has polymerised by overcuring within the space intended for the imprint of the object to be printed.

Finally, in the step shown with reference to FIG. 12, the last step of the bottom-up type photo-curing three-dimensional printing process according to the present invention provides that, exploiting the phenomenon previously described with reference to FIGS. 3 and 5, according to which the object 30 consisting of the second photopolymer material, during the curing phase, does not chemically and mechanically couple with the support 33, the object 30 can be simply detached from the support 33, without the need for any activity of removal of the supports or of post processing. To facilitate the detachment of the object 30, after its formation, from the support 33, it is preferable that the support 33 is made of an elastomeric material, to ensure a certain flexibility.

The object 30 therefore appears to have been completely formed according to the specifications. The support 33 can also be reused for other printings, if you want to produce several copies of the desired object.

FIG. 13 shows a perspective view of a real object 40 to be printed by the photo-curing printing process according to the present invention and of the corresponding support 41.

FIGS. 14-16 show exemplary drawings of respective supports components 33 to show that a respective imprint provided with a respective support component 33 can also comprise at least one undercut section 33a. A respective undercut section 33a can enable a mechanical anchoring of the object 30 inside the imprint of the support component 33. A respective anchoring can improve the (intermediate) mechanical connection between the support component 33 and the object 30 which can be helpful to resist forces generated by the suction-effect during the additive build-up of the object 30.

Particularly, FIG. 14 shows an exemplary undercut configuration of a support component 33 with undercut sections 33a at multiple sides, whereas FIG. 15 shows an exemplary undercut configuration of a support component 33 with an undercut section 33a only at one exemplary side. FIG. 16 shows that respective undercut sections 33a can also comprise curved shapes.

Detachment of the object 30 from the support component 33 is still feasible without damaging the object 30, e.g. because the support component 33 can be printed from an elastic material, such as a rubber-like material, which exhibits some elastic deformation behavior. The object 30 can thus, be detached from the support component 33 by deforming, e.g. by bending, flexing, etc., at least parts of the support component 33 to release the object 30.

FIG. 17 shows a principle drawing of image data for printing the last layer L₃₃ of an exemplary support component 33 and the first layer L₃₀ of an exemplary object 30 according to an exemplary embodiment of the present invention.

FIG. 17 thus, shows that the image data used for printing the first layer of the actual object 30, which image data is indicative of areas to be cured for creating the first layer L₃₀ of the object 30, can correspond to areas which are not to be cured in the image data used for printing at least the last layer L₃₃ of the support component 33. As such, the image data and/or the cross-sectional data, used for printing the first layer L₃₀ of the object 30 can be complementary to the image data and/or the cross-sectional data used for printing the last layer L₃₃ of the support component 33.

Further, FIG. 17 shows what can be understood by extra-polymerisation and overcuring, respectively.

As is apparent from FIG. 17, extra-polymerisation or over-curing typically means that a higher amount of energy is used relative to an amount of energy required for curing a given reference layer thickness t1, which can be a layer thickness used for curing the second and all subsequent layers of the object 30 to be printed. A respective reference layer thickness t1 is exemplarily indicated in FIG. 17. This higher amount of energy will result that a cured layer forming an initial portion of the object 30 is generated which has a greater layer t2 thickness than the reference layer thickness t1. Particularly, this higher amount of energy can lead to a curing of the photopolymer material in multiple directions (including the vertical build-direction). AS This curing of the photopolymer material will take place inside the recess of the support component 33. Thus, the curing of the photopolymer material is not of disadvantage because the respective portion of the object 30 will then be created inside the recess of the support component 33 as shown e.g. in FIG. 10, 11. This also means that extra-polymerisation and overcuring, respectively is typically effected only for curing of the first layer of the actual object 30.

The present invention has been described for illustrative, but not limitative purposes, according to its preferred embodiments, but it is to be understood that variations and/or modifications may be made by those skilled in the art without thereby departing from the relative scope of protection, as defined from the attached claims.

1-15. (canceled)

16. A bottom-up type photo-curing 3D printing process, comprising the following steps:
forming an object to be printed on a support, on which support there is the imprint of at least a portion of the object to be printed, by the photo-curing of a photopolymer material; and
detaching the obtained object from said support.

17. The process according to claim 16, comprising the following preliminary step: applying on an extraction plate a previously formed support.

18. The process according to claim 17, comprising the following preliminary step: applying on an extraction plate a previously formed support comprising a previously printed support.

19. The process according to claim 18, wherein said step of completing the curing of the photopolymer material of said support comprises the following sub-steps:
washing and subsequent drying of the support;
post-curing of the support by exposing its entire surface to ultraviolet radiation and/or by heating.

20. The process according to claim 16, comprising the following preliminary steps:
forming a support on an extraction plate, by the photo-curing of successive layers of a photopolymer material; and
completing the curing of the photopolymer material of said support.

21. The process according to claim 20, wherein said step of completing the curing of the photopolymer material of said support comprises closing the polymerization chains in a percentage higher than 95%.

22. The process according to claim 20, wherein said step of completing the curing of the photopolymer material of said support comprises the following sub-steps:
washing and subsequent drying of the support;
post-curing of the support by exposing its entire surface to ultraviolet radiation and/or by heating.

23. The process according to claim 16, wherein said step of forming the object to be printed on said support includes two sub-steps:
forming a first portion of the object to be printed by polymerization of the photopolymer material of the object within the imprint present on said support;
forming the remaining portion of the object to be printed by the photo-curing of successive layers of said photopolymer material of the object, starting from said first portion.

24. The process according to claim 23, wherein said step of forming the object) to be printed on said support) includes two sub-steps:
forming a first portion of the object) to be printed by extra-polymerization of the photopolymer material of the object within the imprint present on said support;
forming the remaining portion of the object to be printed by the photo-curing of successive layers of said photopolymer material of the object, starting from said first portion.

25. The process according to claim 16, wherein the photopolymer material of the object is the same as the photopolymer material of said support.

26. The process according to claim 16, wherein the photopolymer material of the object is different from the photopolymer material of said support.

27. The process according to claim 26, wherein the photopolymer material of said support is an elastomeric material.

28. The process according to claim 16, wherein the object is an orthodontic device or comprises same.

29. The process according to claim 16, wherein forming a first portion of the object to be printed by polymerization of the photopolymer material of the object within the imprint present on said support comprises curing the photopolymer material with a curing depth of more than 150 μm.

30. The process according to claim 16, wherein the radiation data used for printing the first layer of the object, which radiation data is indicative of areas to be cured for creating the first layer of the object corresponds to areas which are not to be cured in the radiation data used for printing the support.

31. The process according to claim 16, wherein the support is formed with at least one undercut section.

32. A bottom-up type photo-curing 3d-printer configured to perform a bottom-up type photo-curing three-dimensional printing process, wherein the bottom-up type photo-curing 3d-printer comprises a controller which is configured to cause the bottom-up type photo-curing 3d-printer to perform the steps of the bottom-up type photo-curing three-dimensional printing process of claim 16.
